(19) United States
(12) Patent Application Publication
(10) Pub. No.: US 2022/0011044 A1
(43) Pub. Date: Jan. 13, 2022

(54) SYSTEMS AND METHOD FOR CONTROLLING COOLING SYSTEMS

(71) Applicant: Regal Beloit America, Inc., Beloit, WI (US)

(72) Inventors: Paul Steven Mullin, Yellow Springs, OH (US); Kyle Joseph McBrady, Tipp City, OH (US)

(21) Appl. No.: 16/924,822

(22) Filed: Jul. 9, 2020

(51) Int. Cl. F25D 29/00; F25D 11/00

(52) U.S. Cl. CPC F25D 29/003; F25D 11/00; F25D 2700/00; F25D 2600/06; F25D 2500/04

(57) ABSTRACT

A server for a control system for cooling systems is disclosed. The server includes a memory device configured to store instructions and a processor communicatively coupled to the memory device and a plurality of cooling systems. Each of cooling systems includes a motor, a sensor, a local memory, and a microprocessor communicatively coupled to the motor, the sensor, the local memory. The microprocessor is configured to control operation of the motor according to settings defined by configuration data stored in the local memory. In response to reading the instructions, the processor is configured to receive, from the sensor of each of the cooling systems, first sensor data, generate first configuration data by executing a first algorithm on the first sensor data, and instruct the microprocessor of at least one cooling system to write the first configuration data to the local memory of the at least one cooling system.

### BACKGROUND

The field of the disclosure relates generally to a system for controlling and monitoring cooling systems and, more specifically, a control system that enables motor control settings of cooling systems to be remotely reconfigured based on data obtained from sensors.

Cooling systems, such as refrigerators and freezers, are used by entities such as grocery stores and warehouses to store or display foods and beverages at a suitable temperature. At least some such cooling systems include electric motors configured to rotate, for example, a fan or a compressor of the cooling system. Such cooling systems may each have a thermostat that controls the motors of the cooling system, for example, in order to maintain a certain temperature within a space for the cooling system. Thermostats may include a microprocessor and some memory, which may store configuration data for the cooling system. This configuration data is typically static and loaded at the time of manufacturer or installation. Thermostats generally control the motors based on data that can be measured locally by the thermostat, such as temperature, and do not leverage other sources of data. Because these sources of data can be used to improve operating characteristics of the motors, such as energy efficiency, a control system that is capable of leveraging such data to operate motors in cooling systems to achieve greater efficiency is therefore desirable.

### BRIEF DESCRIPTION

In one aspect, a server for a control system for a plurality of cooling systems is disclosed. The server includes a memory device configured to store instructions and a processor communicatively coupled to the memory device and a plurality of cooling systems. Each of the plurality of cooling systems includes a motor, a sensor, a local memory, and a microprocessor communicatively coupled to the motor, the sensor, the local memory. The microprocessor is configured to control operation of the motor according to settings defined by configuration data stored in the local memory. In response to reading the instructions, the processor is configured to receive, from the sensor of each of the plurality of cooling systems, first sensor data, generate first configuration data by executing a first algorithm on the first sensor data, and instruct the microprocessor of at least one cooling system of the plurality of cooling systems to write the first configuration data to the local memory of the at least one cooling system.

In another aspect, a method for controlling a plurality of cooling systems is provided. The method includes receiving, at a processor, first sensor data from a sensor of each of the plurality of cooling systems, generating, by the processor, first configuration data by executing an algorithm on the first sensor data, and instructing, by the processor, a microprocessor of at least one cooling system of the plurality of cooling systems to write the first configuration data to a local memory of the at least one cooling system.

In another aspect, a control system is provided. The control system includes a plurality of cooling systems, each cooling system of the plurality of cooling systems comprising a motor, a sensor, a local memory, and a microprocessor communicatively coupled to the motor, the sensor, and the memory and configured to control operation of the motor according to settings defined by configuration data stored in the memory. The control system further includes a server including a processor communicatively coupled to the plurality of cooling systems and communicatively coupled to a memory device configured to store instructions. In response to reading the instructions, the processor is configured to receive, from the sensor of each of the plurality of cooling systems, first sensor data, generate first configuration data by executing an algorithm on the first sensor data, and instruct the microprocessor of at least one cooling system of the plurality of cooling systems to write the first configuration data to the local memory of the at least one cooling system.

### BRIEF DESCRIPTION OF THE DRAWINGS

FIG. 1 is a block diagram of an exemplary cooling system;

FIG. 2 is a block diagram of an exemplary control system for controlling the cooling system depicted in FIG. 1;

FIG. 3 is a flow diagram of an exemplary method of controlling a plurality of cooling systems; and

FIG. 4 is an exemplary user interface that may be displayed by the control system depicted in FIG. 2.

### DETAILED DESCRIPTION

Embodiments of the control system and methods of controlling a cooling system described herein utilize a cloud network to generate data (sometimes referred to herein as “configuration data”) that define settings according to which the motors of individual cooling systems are controlled. The control system uses sensor data obtained from each of the cooling systems in addition to other data input from users or retrieved from sources within the cloud network to generate the configuration data, and instructs microcontrollers of the cooling systems to control corresponding motors according to the generated configuration data. Accordingly, the configuration data may be generated using an increased number and variety of data sources such that, when set for a particular cooling system, the configuration data improve performance characteristics of the cooling system, such as energy efficiency or an ability of the cooling system to maintain a particular demanded temperature.

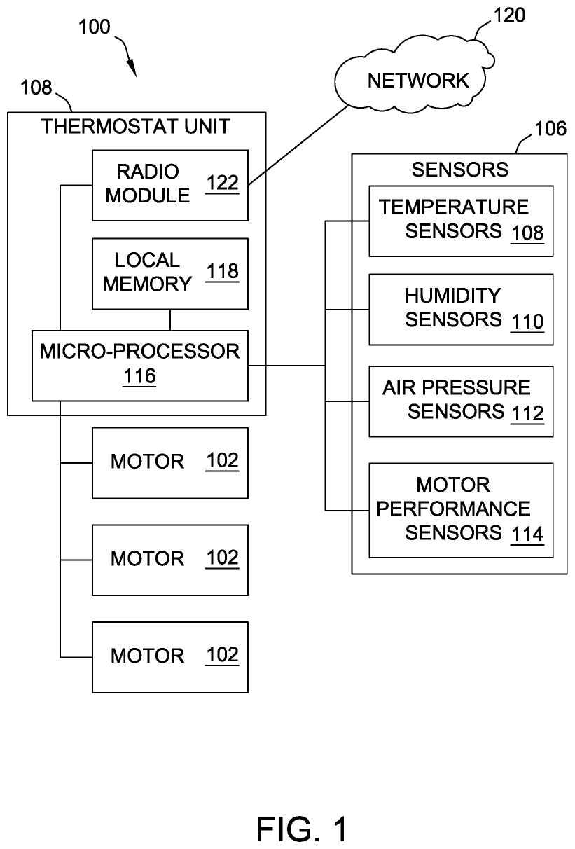

FIG. 1 is a block diagram of an exemplary cooling system 100. Cooling system 100 may include one or more motors 102, a thermostat unit 104, and one or more sensors 106 such as, for example, a temperature sensor 108, a humidity sensor 110, an air pressure sensor 112, and a motor performance sensor 114. In some embodiments, cooling system 100 is a refrigerator or freezer having a cabinet defining an interior space cooled by components of cooling system 100. In such embodiments, the cabinet has a door or opening though which contents may be inserted, stored, or displayed in cooling system 100.

Motors 102 use electrical power to rotate a mechanical load. For example, motors 102 may be mechanically coupled to a condenser fan, an evaporator fan, or a compressor of cooling system 100. As such, motors 102 enable the cooling of a defined space in flow communication with cooling system 100 such as, for example, a food storage space of a refrigerator or freezer. In certain embodiments, motors 102 are electronically commutated motors (ECMs). Motors 102 are communicatively coupled to thermostat unit 104, and are configured to operate in response to a control signal generated by thermostat unit 104. Motors 102 are capable of changing operation based on the control signal. For example, in response to the control signal, motors 102 may activate or deactivate, or operate according to a specified speed, torque, power, or other parameter.

Sensors 106 are configured to detect physical properties of cooling system 100 or its environment, and generate a sensor signal that represents data (sometimes referred to herein as “sensor data”) collected by sensors 106. For example, temperature sensor 108 detects a temperature at the location of temperature sensor 108 such as, for example, an evaporator inlet, an evaporator outlet, a thermal expansion valve, inlet air, outlet air, motors 102, or an ambient temperature of an area cooled by cooling system 100. Based on the detected temperature, temperature sensor generates a sensor signal including the temperature data. For example, the sensor signal may be an analog or digital signal including encoded temperature data. Humidity sensor 110 detects humidity, air pressure sensor 112 detects an air pressure, and motor performance sensor 114 detects operating performance characteristics of motors 102, such as, for example, a speed, torque, fault status, energy use, power, vibration, or run time of motors 102. Humidity sensor 110, air pressure sensor 112, and motor performance sensor 114 may generate a sensor signal to transmit sensor data in a similar manner as described with respect to temperature sensor 108. Cooling system 100 may also include additional sensors to detect other properties of cooling system 100 and its environment.

Thermostat unit 104 includes a microprocessor 116 and a local memory 118. In some alternative embodiments, microprocessor 116 and local memory 118 are incorporated into one or more of motors 102. Microprocessor 116 is communicatively coupled to motors 102 and sensors 106 using, for example, a wired Modbus connection. Microprocessor 116 is configured to read instructions stored in local memory 118 and generate the control signal for motors 102 based on the instructions and sensor data received from sensors 106. Such instructions include data (sometimes referred to herein as “configuration data”) that define settings under which microprocessor 116 controls the operation of motors 102, for example, by specifying a particular control signal output for a given sensor data input. For example, in some embodiments, microprocessor 116 receives temperature data from temperature sensor 108 and selects a speed, torque, or power at which to operate one or more of motors 102 by executing an algorithm on the received temperature data such as, for example, a lookup table or a formula (e.g., a polynomial function determined by regression analysis). In some embodiments, microcontroller further controls operation of motors 102 based on humidity data, air pressure data, motor performance data, other data, or a combination thereof in a similar manner as described with respect to temperature data.

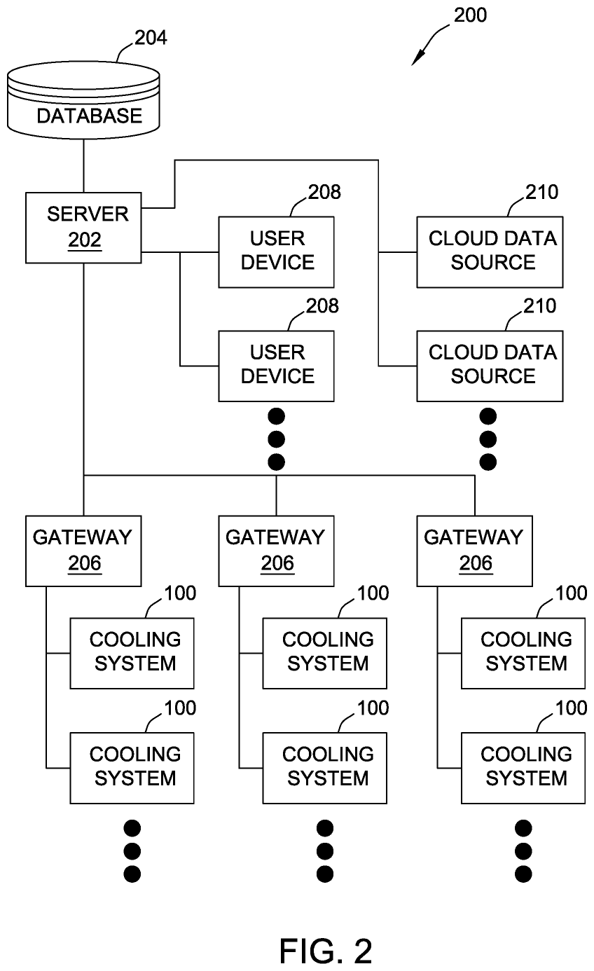

Thermostat unit 104 is further in communication with a network 120 (shown in more detail with respect to FIG. 2). For example, in some embodiments, thermostat unit 104 further includes a radio module 122 communicatively coupled to microprocessor 116, through which microprocessor 116 can communicate with network 120. In some embodiments, radio module 122 is configured communicate with other elements of the network using a specific communications protocol such as, for example, ZigBee 3.0 or Bluetooth Low Energy.

As described in further detail with respect to FIG. 2, communicating with network 120 enables microprocessor 116 to receive new or updated configuration data, or instructions to modify configuration data, and write the updated configuration data to local memory 118, or modify the configuration data stored in local memory 118. Accordingly, the settings under which microprocessor 116 controls motors 102 may be adjusted remotely. In some embodiments, microprocessor 116 is further configured to transmit sensor data received from sensors 106 to other locations of network 120.

FIG. 2 is a block diagram of an exemplary control system 200. Control system 200 includes a plurality of cooling systems 100, a server 202, a database 204, one or more gateways 206, one or more user devices 208, and one or more cloud data sources 210. Cooling systems 100 generally function as described with respect to FIG. 1. Network 120 shown in FIG. 1 may include one or more of server 202, database 204, user devices 208, cloud data sources 210, and other cooling systems 100.

Server 202 is communicatively coupled to each cooling system 100. In some embodiments, each cooling system 100 is communicatively coupled with one of the plurality of gateways 206, for example, via a wireless connection, such as a Bluetooth or ZigBee connection, or via a wired connection, such as an Ethernet connection. Each gateway 206 is in turn communicatively coupled to server 202 to form a communicative connection between each cooling system 100 and server 202. In some embodiments, each gateway 206 and server 202 are communicatively coupled via the Internet, for example, via one or more of a wireless local area network (WLAN), a cellular network, or another computer network that allows data to be exchanged between server 202 and each gateway 206. To enable data exchange between server 202, gateway 206, and other components of control system 200, such networks may utilize various communications protocols such as, for example, Wi-Fi, Ethernet, Bluetooth, or ZigBee. In some embodiments, each gateway 206 corresponds to a specific site such as, for example, a store or warehouse having one or more cooling systems 100.

As described with respect to FIG. 1, each cooling system includes a microprocessor 116 (shown in FIG. 1) configured to read configuration data from and write configuration data to local memory 118 (FIG. 1). Server 202 includes a processor configured to generate configuration data and instruct the microprocessor 116 of each cooling system 100 to write the generated configuration data to local memory 118. Alternatively, in some embodiments, server 202 writes configuration data directly to local memory 118 or to a memory incorporated into one or more of motors 102. By so doing, server 202 is capable of modifying the configuration data and corresponding settings of each cooling system 100. Server 202 generates the modified configuration data based on one or more data inputs such as, for example, manual user input, sensor data obtained from cooling systems 100, or data obtained from cloud data sources 210 (e.g., via the Internet). Server 202 may execute algorithms on such input data to generate configuration data. For example, in some embodiments, server 202 is configured to generate configuration data by executing on the received input data an algorithm such as, for example, a lookup table or a formula (e.g., a polynomial function determined by regression analysis). Additionally, or alternatively, in some embodiments, server 202 may further be configured to generate configuration data using artificial intelligence (AI) or machine learning techniques.

In some embodiments, algorithms executed by server 202 to generate configuration data include, for example, energy use reduction or load shaving algorithms, wherein cooling systems 100 are reconfigured to reduce a fan speed of motors 102 during times of predicted peak energy cost. In some such embodiments, server 202 uses data received from cooling systems 100. For example, cooling systems 100 corresponding to cabinets with high-value food at risk of spoiling may be excluded from the reduction of fan speeds, or cooling systems 100 corresponding to cabinets showing temperature rise may have fan speeds restored to a higher level. Other algorithms executed by server 202 produce a data output, but not necessarily a control output. Such algorithms may be used by server 202 to verify that certain manually or locally deployed routines are actually being executed by cooling systems 100. For example, motor performance data and/or temperature data can be used to determine when defrost cycles occur, how long defrost cycles last, and how frequently defrost cycles occur for a particular cooling system 100. In some such embodiments, server 202 may determine that an alarm or error condition is present based defrost cycles are missing or stopped, for example, by comparing expected motor performance data and/or temperature data to actual data received from sensors 106.

Using such algorithms, server 202 can generate configuration data that causes cooling systems 100 to achieve certain operating characteristics, such as operating with greater energy efficiency. For example, an environment (e.g., external weather, temperature, humidity, air pressure, etc.) of a cooling system 100 may affect its ability to meet a cooling demand while operating motors 102 at a certain power level. By generating configuration data for each cooling system 100 at server 202, the configuration data stored at each cooling system 100 can be set, for example, to cause motors 102 of each cooling system 100 to operate at a minimum power level that still allows the corresponding cooling system 100 to meet its cooling demand requirement. This power level may be different for each cooling system 100 or groups of cooling systems 100 (e.g., the cooling systems at a particular store), and as such, server 202 is configured to separately generate configuration data for each cooling system 100 or group of cooling systems 100.

In some embodiments, server 202 is further communicatively coupled to database 204. In some such embodiments, server 202 stores sensor data received from cooling systems 100 in database 204. As described above, server 202 can use such sensor data as a data input for generating updated configuration data. Server 202 can further use such sensor data to compute statistics such as, for example, average energy usage for a given cooling system 100 or set of cooling systems 100.

In some embodiments, server 202 is further communicatively coupled to user devices 208. User devices 208 may be, for example, personal computers (PCs), tablet computers, smart telephones, and/or other such computing devices. In such embodiments, server 202 is configured to cause user devices 208 to display a user interface, through which a user may interact with control system 200. For example, in some such embodiments, user devices 208 are configured to run an application, or “app,” through which a user may, for example, adjust settings for cooling systems 100 or view data related to cooling systems 100, such as, for example, total usage, energy usage, or error data. In some such embodiments, server 202 is configured to compute one or more metrics based on received sensor data such as, for example, an average energy usage, average power, or total amount of time activated of a particular cooling system 100, motor 102, or group of cooling systems corresponding to a particular site or gateway 206. In such embodiments, server 202 is configured to instruct user devices 208 to display the computed metric via the user interface. In certain such embodiments, the user interface displayed at each user device 208 may enable to the user to input commands to control one or more of cooling systems 100. In such certain embodiments, each user device 208 generates a command message and transmits the command message to server 202. In response to the command message, server 202 generates updated configuration data and instructs microprocessor 116 of a cooling system 100 specified by the user input to write the second configuration data to local memory 118 of the specified cooling system 100.

In some embodiments, server 202 is further communicatively coupled to cloud data sources 210. Examples of cloud data sources 210 include computing devices and databases from which server 202 can retrieve data (sometimes referred to herein as “cloud data”) via a network connection (e.g., via the Internet). For example, in some embodiments, cloud data sources 210 include one or more of sources of weather data, sources of data regarding the sites of cooling systems 100 (e.g., computers associated stores or warehouses owning one or more of cooling systems 100), or other sources of data relevant to the operating environment of cooling systems 100. Such data can pertain to, for example, weather, location, a holiday schedule, reviews, local events, operating hours, names, energy costs, photos, names, styles, or models of cabinets corresponding cooling systems 100, occupancy of a site or aisle corresponding to cooling systems 100, or whether a cabined door corresponding to cooling system 100 is open or closed. In such embodiments, server 202 is configured to retrieve such data from cloud data sources 210, generate updated configuration data based on the retrieved data, and instruct microprocessor 116 of a cooling system 100 specified by the user input to write the second configuration data to local memory 118 of the specified cooling system 100. For example, server 202 may generate configuration data for a given cooling system 100 taking into account, for example, an outside temperature and/or humidity of a location of the given cooling system 100.

In some embodiments, server 202 communicates directly with sensors 106 of each cooling system 100, rather than through thermostat unit 104. In such embodiments, sensors 106 can be installed onto existing equipment, enabling server 202 to monitor the existing equipment, for example, by monitoring the health of motors 102, cooling systems 100, and/or groups of cooling systems 100 as a whole. For example, server 202 can detect failed temperature control, defrost cycles, low refrigerant charge, or other parameters using sensors 106. Further, in some such embodiments, server 202 can detect though secondary means what a local controller such as thermostat unit 104 is doing, for example, by detecting when cooling system 100 is cooling based on temperature, motor torque, motor vibration, and/or other indicator properties of cooling system 100 and its components.

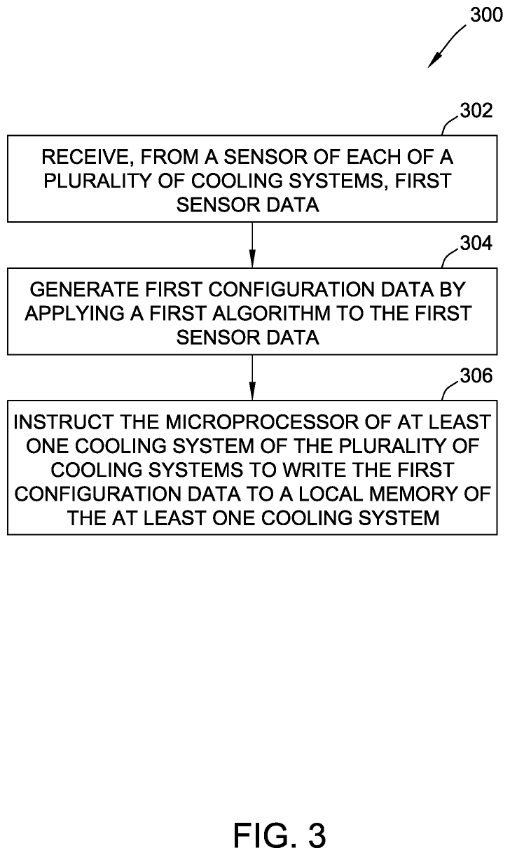

FIG. 3 is a flow diagram of an exemplary method 300 of controlling cooling systems, such as cooling system 100 shown in FIG. 1. Method 300 may be embodied in a control system having a server, such as control system 200 and server 202 shown in FIG. 2. Control system 200 may perform method 300 periodically or in response to certain events such as, for example, input from a user or a sensor.

Server 202 receives 302, from sensors 106 of each of the plurality of cooling systems 100, first sensor data. In some embodiments, the first sensor data is generated by one or more of temperature sensor 108, humidity sensor 110, air pressure sensor 112, motor performance sensor 114, and another type of sensor 106 included in cooling system 100, and is transmitted to server 202 by microprocessor 116 via radio module 122 and gateway 206.

Server 202 then generates 304 first configuration data by executing a first algorithm on the first sensor data. In some embodiments, the first algorithm is one or more of a lookup table or a formula (e.g., a polynomial function determined by regression analysis) that generates given output configuration data based on a particular combination of input sensor data. The first sensor data defines updated operating settings according to which microprocessor 116 may control motors 102.

Server 202 then instructs 306 microprocessor 116 of at least one cooling system 100 of the plurality of cooling systems 100 to write the first configuration data to local memory 118 of the at least one cooling system 100. For example, in some embodiments, server 202 compiles instructions based on the generated configuration and transmits the instructions to microprocessor 116 via gateway 206 and radio module 122. The instructions, when executed by microprocessor 116, cause microprocessor 116 to write the first configuration data to local memory 118. Once the first configuration data is stored in local memory 118, microprocessor 116 controls motors 102 based on settings defined by the first configuration data.

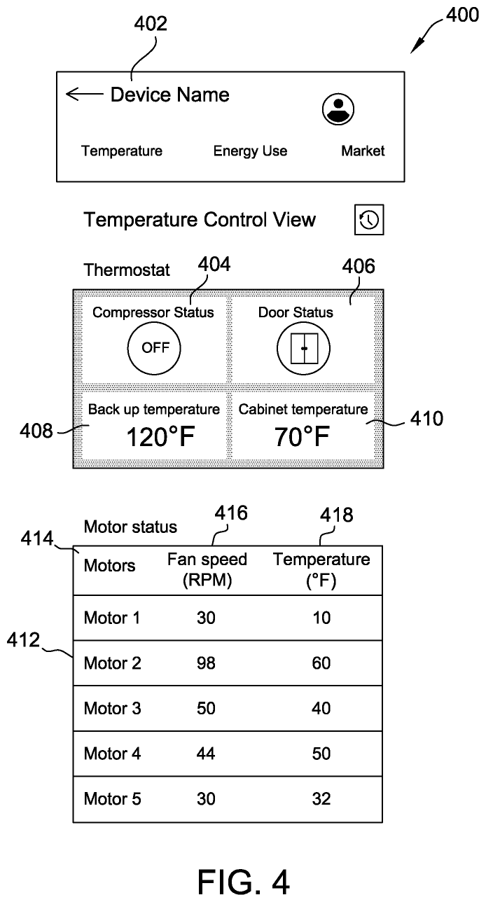

FIG. 4 is an exemplary user interface 400 for controlling and viewing information about cooling systems 100 (shown in FIG. 1) of control system 200 (shown in FIG. 2). In some embodiments, user interface 400 is displayed by user device 208 in response to instructions received from server 202. User interface 400 may be, for example, a web page or app page. For example, user interface 400 may be generated using one or more of an Android or iOS phone app and an Azure web app. In the example embodiment in FIG. 4, user interface 400 displays information related to temperature in cooling system 100. In alternative embodiments, user interface displays other information relating to cooling systems 100 or gateways 206 or options to control cooling systems 100, as described with respect to FIG. 2.

User interface 400 includes a device name indicator 402. Device name indicator 402 displays a name of a particular cooling system 100 associated with user interface 400. For example, user interface 400 may be displayed in response to selecting the particular cooling system 100 from a list via input at user device 208.

User interface 400 further includes status indicators, including a compressor status indicator 404, a door status indicator 406, a backup temperature indicator 408, and a cabinet temperature indicator 410. Compressor status indicator 404 indicates whether a motor 102 coupled to a compressor of cooling system 100 is on or off. Door status indicator 406 indicates whether a cabinet door of cooling system 100 is open or closed. Backup temperature indicator 408 indicates a backup temperature of cooling system 100. Cabinet temperature indicator 410 indicates a current cabinet temperature of cooling system 100. In other embodiments, user interface may include additional or alternative status indicators that display other information, such as the information described with respect to sensors 106 in FIG. 1 and cloud data sources 210 in FIG. 2.

User interface 400 further includes a motor status table 412 that displays information about motors 102 of cooling system 100. Motor status table 412 includes a motor name field 414, which indicates a name of one or more motors 102 (e.g., fan motors) of cooling system 100. Motor status table 412 further includes a fan speed field 416, which indicates a current fan speed of each motor 102 represented in motor status table 412. Motor status table further includes a temperature field 418, which indicates a current temperature of each motor 102 represented in motor status table 412. In other embodiments, motor status table 412 may include additional or alternative fields corresponding to information about motors 102, such as the information described with respect to sensors 106 in FIG. 1.

The methods and systems described herein may be implemented using computer programming or engineering techniques including computer software, firmware, hardware or any combination or subset thereof, wherein the technical effect may include at least one of: (a) improving energy efficiency of motors in cooling systems by operating the motors according to settings defined by configuration data generated based on sensor data; and (b) increasing the efficiency by which a user may control cooling systems located at various sites by utilizing a server communicatively coupled to a user device that displays a user interface and communicatively coupled to the cooling systems through a combination of gateways and wireless connections.

In the foregoing specification and the claims that follow, a number of terms are referenced that have the following meanings.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here, and throughout the specification and claims, range limitations may be combined or interchanged. Such ranges are identified and include all the sub-ranges contained therein unless context or language indicates otherwise.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processor, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processing (DSP) device, an application specific integrated circuit (ASIC), and other programmable circuits or processing devices capable of executing the functions described herein, and these terms are used interchangeably herein. The above embodiments are examples only, and thus are not intended to limit in any way the definition or meaning of the terms processor, processing device, and related terms.

In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal. Alternatively, a floppy disk, a compact disc-read only memory (CD-ROM), a magneto-optical disk (MOD), a digital versatile disc (DVD), or any other computer-based device implemented in any method or technology for short-term and long-term storage of information, such as, computer-readable instructions, data structures, program modules and sub-modules, or other data may also be used. Therefore, the methods described herein may be encoded as executable instructions, e.g., “software” and “firmware,” embodied in a non-transitory computer-readable medium. Further, as used herein, the terms “software” and “firmware” are interchangeable, and include any computer program stored in memory for execution by personal computers, workstations, clients and servers. Such instructions, when executed by a processor, cause the processor to perform at least a portion of the methods described herein.

Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

The systems and methods described herein are not limited to the specific embodiments described herein, but rather, components of the systems and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A server for a control system for a plurality of cooling systems, said server comprising:
a memory device configured to store instructions; and
a processor communicatively coupled to said memory device and a plurality of cooling systems, each of the plurality of cooling systems including a motor, a sensor, a local memory, and a microprocessor communicatively coupled to the motor, the sensor, and the local memory, the microprocessor configured to control operation of the motor according to settings defined by configuration data stored in the local memory, wherein in response to reading the instructions, said processor is configured to:
receive, from the sensor of each of the plurality of cooling systems, first sensor data;
generate first configuration data by executing a first algorithm on the first sensor data; and
instruct the microprocessor of at least one cooling system of the plurality of cooling systems to write the first configuration data to the local memory of the at least one cooling system.

2. The server of claim 1, wherein said processor is further coupled to a plurality of gateways, and wherein said processor is communicatively coupled to each cooling system of the plurality of cooling systems via the plurality of gateways.

3. The server of claim 2, wherein said processor is further communicatively coupled to each cooling system via a radio module communicatively coupled to the microprocessor and configured to wirelessly communicate with the gateway.

4. The server of claim 1, wherein said processor is further communicatively coupled to a user device, and is further configured to instruct the user device to display a user interface.

5. The server of claim 4, wherein said processor is further configured to:
receive, from the user device, a command message generated in response to a user input;
generate second configuration data in response to the command message; and
instruct the microprocessor of at least one cooling system of the plurality of cooling systems to write the second configuration data to the local memory of the at least one cooling system.

6. The server of claim 4, wherein said processor is further configured to:
compute, based on the first sensor data, a metric corresponding to at least one of a cooling system of the plurality of cooling systems or a motor of the plurality of cooling systems; and
instruct the user device to display the metric via the user interface.

7. The server of claim 1, wherein said server is communicatively coupled to a cloud data source, and said processor is further configured to:
retrieve cloud data from the cloud data source;
generate second configuration data by executing a second algorithm on the cloud data; and
instruct the microprocessor of at least one cooling system of the plurality of cooling systems to write the second configuration data to the local memory of the at least one cooling system.

8. A method for controlling a plurality of cooling systems, said method comprising:
receiving, at a processor, first sensor data from a sensor of each of the plurality of cooling systems;
generating, by the processor, first configuration data by executing an algorithm on the first sensor data; and
instructing, by the processor, a microprocessor of at least one cooling system of the plurality of cooling systems to write the first configuration data to a local memory of the at least one cooling system.

9. The method of claim 8 further comprising instructing, by the processor, a user device to display a user interface.

10. The method of claim 9, further comprising:
receiving, at the processor, from the user device, a command message generated in response to a user input;
generating, by the processor, second configuration data in response to the command message; and
instructing, by the processor, the microprocessor of at least one cooling system of the plurality of cooling systems to write the second configuration data to the local memory of the at least one cooling system.

11. The method of claim 9, further comprising:
computing, by the processor based on the first sensor data, a metric corresponding to at least one of a cooling system of the plurality of cooling systems or a motor of the plurality of cooling systems; and
instructing, by the processor, the user device to display the metric via the user interface.

12. The method of claim 8 further comprising:
retrieving, by the processor, cloud data from a cloud data source;
generating, by the processor, second configuration data by executing a second algorithm on to the cloud data; and
instructing, by the processor, the microprocessor of at least one cooling system of the plurality of cooling systems to write the second configuration data to the local memory of the at least one cooling system.

13. A control system, said control system comprising:
a plurality of cooling systems, each cooling system of said plurality of cooling systems comprising
a motor;
a sensor;
a local memory; and
a microprocessor communicatively coupled to said motor, said sensor, and said memory and configured to control operation of said motor according to settings defined by configuration data stored in said memory; and
a server comprising a processor communicatively coupled to said plurality of cooling systems and communicatively coupled to a memory device configured to store instructions, wherein in response to reading the instructions, said processor is configured to:
receive, from said sensor of each of said plurality of cooling systems, first sensor data;
generate first configuration data by executing an algorithm on the first sensor data; and
instruct said microprocessor of at least one cooling system of said plurality of cooling systems to write the first configuration data to said local memory of said at least one cooling system.

14. The control system of claim 13, further comprising a plurality of gateways, wherein each cooling system of said plurality of cooling systems is communicatively coupled to said processor via a gateway of said plurality of gateways.

15. The control system of claim 14, wherein each cooling system further comprises a radio module communicatively coupled to said microprocessor and configured to wirelessly communicate with said gateway.

16. The control system of claim 13, further comprising a user device, wherein said processor is further communicatively coupled to said user device and is further configured to instruct said user device to display a user interface.

17. The control system of claim 16, wherein said processor is further configured to:
receive, from said user device, a command message generated in response to a user input;
generate second configuration data in response to the command message; and
instruct said microprocessor of at least one cooling system of said plurality of cooling systems to write the second configuration data to said local memory of the at least one cooling system.

18. The control system of claim 16, wherein said processor is further configured to:
compute, based on the first sensor data, a metric corresponding to at least one of a cooling system of said plurality of cooling systems or a motor of said plurality of cooling systems; and
instruct said user device to display the metric via the user interface.

19. The control system of claim 13, wherein said sensor of each cooling system of said plurality of cooling systems comprises at least one of a temperature sensor, a humidity sensor, an air pressure sensor, or a motor performance sensor.

20. The control system of claim 13, wherein said microprocessor of each cooling system of said plurality of cooling systems is configured to control said motor of said cooling system according to at least one of a speed, a torque, or a power.
